(19) United States
(12) Patent Application Publication
(10) Pub. No.: US 2021/0382142 A1
(43) Pub. Date: Dec. 9, 2021

(54) MICROLENS ARRAY LIDAR SYSTEM

(71) Applicant: Pointcloud Inc., San Francisco, CA (US)

(72) Inventors: Christopher Martin Sinclair Rogers, Palo Alto, CA (US); Alexander Yukio Piggott, San Mateo, CA (US); Remus Nicolaescu, San Francisco, CA (US)

(21) Appl. No.: 17/341,704

(22) Filed: Jun. 8, 2021

Related U.S. Application Data
(60) Provisional application No. 63/036,114, filed on Jun. 8, 2020.

(51) Int. Cl. G01S 7/484; G01S 17/894; G01S 7/4861; G01S 17/34

(52) U.S. Cl. CPC G01S 7/484; G01S 17/894; G01S 7/4817; G01S 17/34; G01S 7/4861

(57) ABSTRACT

An integrated light detection and ranging (LiDAR) architecture can contain a focal plane transmitter array, and a focal plane coherent receiver for which the number of receiving elements is the same as the number of emitting elements. A microlens array may be used to achieve parity between the number of receiver and transmitter elements. The integrated LiDAR transmitter can contain an optical frequency chirp generator and a focal plane optical beam scanner with integrated driving electronics. The integrated LiDAR receiver architecture can be implemented with per-pixel coherent detection and amplification.

### PRIORITY

This application claims the benefit of priority to U.S. Provisional Patent Application Ser. No. 63/036,114, filed Jun. 8, 2020, which is incorporated by reference herein in its entirety.

### BACKGROUND

Conventional light detection and ranging systems (LIDAR) systems are bulky and difficult to integrate into a compact chip package in a commercially practical approach.

### BRIEF DESCRIPTION OF THE DRAWINGS

To easily identify the discussion of any particular element or act, the most significant digit or digits in a reference number refer to the figure (“FIG.”) number in which that element or act is first introduced.

FIG. 1 shows a separate transmitter and receiver configuration for a LiDAR based coherent 3D imaging camera, according to some example embodiments.

FIG. 2 shows a block diagram of the transmitter, receiver, and signal processor for a LiDAR based coherent 3D imaging camera using two separate focal plane arrays for the transmitter and receiver and two separate outbound and inbound path configurations, according to some example embodiments.

FIG. 3 shows an example of a dual focal plane array implementation of a LiDAR based 3D imaging system with non-overlapping transmit and receive paths where a single transmitter pixel provides illumination of the target area corresponding to a plurality of receiver pixels, according to some example embodiments.

FIG. 4 shows an example of a dual focal plane array implementation of a LiDAR based 3D imaging system with non-overlapping transmit and receive paths where a single transmitter pixel provides illumination of the target area corresponding to a plurality of receiver pixels for which a microlens array has been introduced on the outbound path in order to segment the transmit beam into a number of sub-beams equal to the number of receiver pixels imaging the patch of the target being illuminated by the transmit pixel, according to some example embodiments.

FIG. 5 shows ray tracing details of a dual focal plane array implementation of a LiDAR based 3D imaging system using a microlens array on the outbound/transmitter optical path, according to some example embodiments.

FIG. 6 shows ray details tracing of a single focal plane array implementation of a LiDAR based 3D imaging system using a microlens array on the common outbound/inbound optical path, according to some example embodiments.

FIG. 7 shows a transmitter/receiver configuration of a single focal plane array implementation of a LiDAR based 3D imaging system, according to some example embodiments.

FIG. 8 shows focal plane array imaging using grating couplers that emit at an angle with respect to the normal of the array and use of a micro prism array to correct for the departure from normal to the array emission, according to some example embodiments.

FIG. 9 shows imaging micro optics elements used to correct for angle of incidence on the array, according to some example embodiments.

FIG. 10 shows a dual focal plane array implementation of a LiDAR based 3D imaging system with overlapping transmit and receive paths where a single transmitter pixel provides illumination of the target area corresponding to a single receiver pixel, according to some example embodiments.

FIG. 11 shows a dual focal plane array implementation of a LiDAR based 3D imaging system with overlapping transmit and receive paths where a single transmitter pixel provides illumination of the target area corresponding to a single receiver pixel and the transmitter electronic driver chip is separated from the photonic chip, according to some example embodiments.

FIG. 12 shows a dual focal plane array implementation of a LiDAR based 3D imaging system with overlapping transmit and receive paths where a single transmitter pixel provides illumination of the target area corresponding to a single receiver pixel and the transmitter electronic driver chip is separated from the photonic chip, according to some example embodiments.

FIG. 13 shows an example of a dual focal plane array implementation of a LiDAR based 3D imaging system with overlapping transmit and receive paths where a single transmitter pixel provides illumination of the target area corresponding to a single receiver pixel and the transmitter electronic driver chip is separated from the photonic chip and connected using an interposer, according to some example embodiments.

FIG. 14 shows a dual focal plane array implementation of a LiDAR based 3D imaging system with overlapping transmit and receive paths where a single transmitter pixel provides illumination of the target area corresponding to multiple pixels on the receiver array with the beam from each transmitter pixel being separated into multiple beams using an array of microlenses, according to some example embodiments.

FIG. 15 shows an example of a dual focal plane array implementation of a LiDAR based 3D imaging system with overlapping transmit and receive paths where a single transmitter pixel provides illumination of the target area corresponding to a single pixel on the receiver array while the pixel to pixel separation on the transmitter and receiver arrays is not identical, according to some example embodiments.

FIG. 16 shows an example method for generating ranging information, according to some example embodiments.

FIG. 17 shows an example point cloud, according to some example embodiments.

Descriptions of certain details and implementations follow, including a description of the figures, which may depict some or all of the embodiments described below, as well as discussing other potential embodiments or implementations of the inventive concepts presented herein. An overview of embodiments of the disclosure is provided below, followed by a more detailed description with reference to the drawings.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

Described below is an architecture of a LiDAR based 3D imaging system composed of a photonic integrated circuit (PIC) transmitter and a photonic integrated circuit receiver array. Both the transmitter and the receiver are setup in a focal plane configuration each imaged with the help of a lens which in some embodiments may be the same lens. The transmitter serves to generate an optical signal with a chirped optical frequency and to perform a two axis scan of the optical beam over the region of interest. The receiver array serves to detect the difference in frequency between the return signal and a local copy of the signal using coherent detection techniques for each pixel of the two dimensional array. In one implementation all the transmitter functions are implemented on one PIC and all functions of the receiver are implemented on a second PIC.

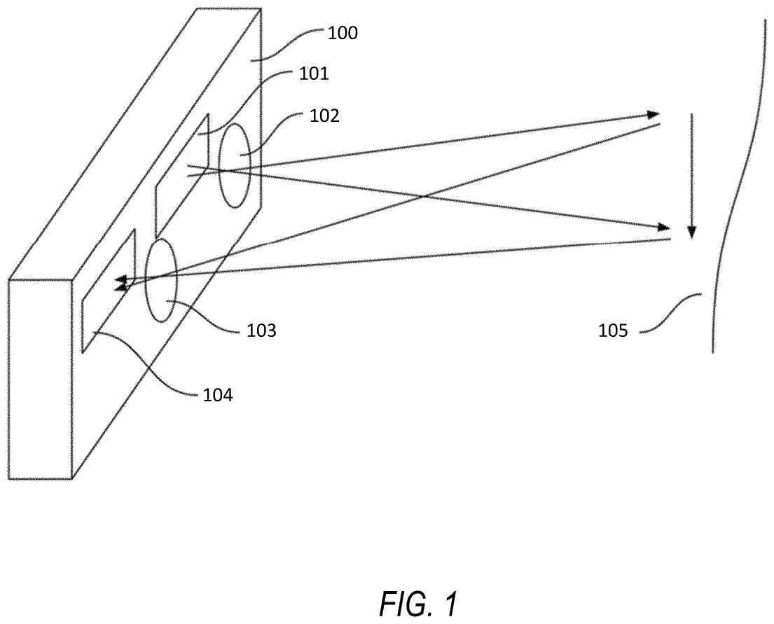

An example architecture 100 is shown in FIG. 1, according to some example embodiments. In FIG. 1, an optical beam having a modulated optical frequency is directed perpendicular to the transmitter PIC 101 successively from a plurality of couplers on the surface of the PIC and collimated with the help of lens 102 and directed towards the region of interest 105. The function of directing the beam to a plurality of couplers on the surface of the chip is accomplished by an in plane optical switch. The scattered signal from region of interest 105 is captured by lens 103 and directed to the plurality of pixels located on the surface of receiver PIC 104 where couplers direct the light into the plane of the chip. Once on the plane of the chip the optical signal is combined with a copy of the local optical signal for each pixel of the receiver array and the frequency difference between the two signals is measured to generate data characterizing the region of interest (e.g., ranging data, velocity, etc.).

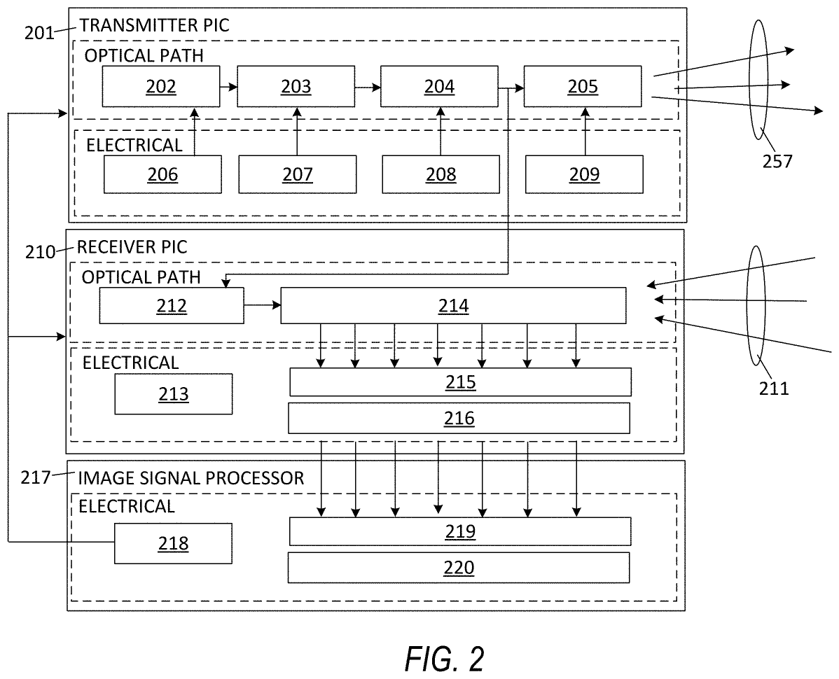

FIG. 2 illustrates a next layer of detail for the transmitter side, according to some example embodiments. The optical switch being integrated with the electronic switches on the same chip. Integration with electronic switches on the chip allows for efficient scaling of this system to large switch arrays, where the I/O requirements would be otherwise prohibitive.

In addition, integration of photodiodes into a tree of thermo-optic switches allows for the automatic detection and calibration of optical voltage/currents to drive the heaters, to maximize extinction ratio for maximum delivery of optical power to the desired output port. This also allows the system to correct for changes in ambient temperature, or other shifts that may affect switch operation. No special equipment is required, and calibration can be performed on the fly, even while a product is in operation. In addition, integration of several other electrical and optical functions into a single platform is described.

On the receiver side, the circuit architectural design of array-based LiDAR coherent receivers can include integrated electronics for amplification and multiplexing. For this design, each pixel in the array is a separate coherent receiver. Focusing is provided by a lens for which the receive array lies at the focal plane.

The circuit architectural design provides a modular and scalable approach to design large arrays of pixels. The modular block size is determined by the number of pixels able to efficiently receive the LO signal, the optical efficiency in illuminating the block with the reflected signal in terms of lens design and transmit power, and the number of parallel readout channels supported by the system signal processing capability.

The architecture includes circuit strategies for amplification and multiplexing to effectively generate multiple parallel readout channels. For very large arrays, additional amplifiers can be added between groupings of modular blocks in order to maintain high-speed operation over physically long metal routes and the associated parasitic capacitance.

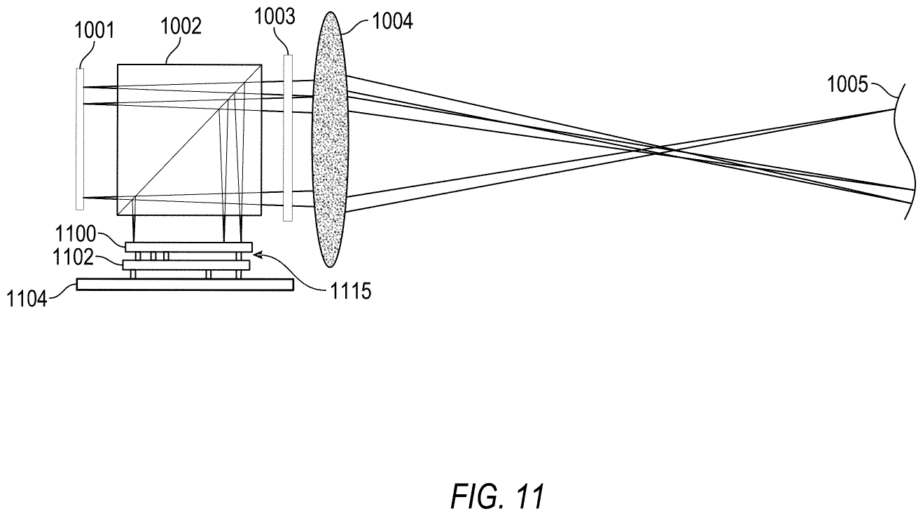

In some example embodiments, such as those illustrated in FIGS. 11, 12 and 13, the optical and electronic functions that are part of the transmitter module may be separated on two different integrated circuits and tightly integrated in a common package using through silicon vias and interposer technology. The advantage of such approach is that two different process technologies can be used: one for the photonic integrated circuitry and one for the electronic circuits powering the active optical components. In one embodiment the photonic integrated circuit (PIC) may be manufactured using a Silicon Photonics process and silicon on insulator wafer with a wide range of silicon epitaxial layer thickness so that it allows for optimization of the optical properties such as for example the needed power handling capabilities of the PIC, while the electronic integrated circuit (EIC) may be manufactured on a different process that allows optimization of the electrical properties of the EIC.

According to some example embodiments, a solid state 3D imaging device exhibiting high performance as described by high resolution, large number of pixels per frame, high frame rate and low form factor and power, in a nutshell a “camera like” device that provides a point cloud and velocity map instead of a grey scale image does not exist today due to a number of technology challenges is here disclosed.

The architecture described here provides a modular, scalable approach for any lensed focal-plane array of coherent detectors, regardless of number of pixels, aspect ratio, and number of readout channels. For the transmitter side the architecture described here provides a modular, scalable approach to building large scale switching arrays necessary for efficient 2 axis solid state beam scanning. At the system level, the integrated architectures presented both on the transmitter and receiver side enable the scaling necessary to achieve a new class of 3D imaging devices with very high efficiency and never before achieved performance on a low cost platform that can easily be deployed into high volume production.

In one embodiment, 3D imaging systems using Frequency Modulation Continuous Wave (FMCW) LiDAR ranging is implemented in which a transmitter source generates a frequency modulated signal that is scanned using a steering mechanism to scan the beam across the target area, and light reflected from the targets are received by a receiver or plurality of receivers. Some conventional approaches employ a mechanical beam scanning mechanism that are generally large, consume higher amounts of energy, and lack optical efficiency. The number of parallel channels being used is typically in the few tens due to practical implementation considerations and the cost constraints that come with a system built using discrete parts. In some example embodiments, a solid state architecture can be implemented for FMCW ranging using a phased array approach for steering. The electronically-controllable phased array approach focuses light across the target and then the reflected signal is mapped back into the detector. The difference from an optical phased array to the lensed focal-plane array is that in the former the optical signal is received by the entire array and combined in the on-chip photonics to produce a single pixel of information. In the latter, each receive pixel corresponds to a pixel of information from the target. Thus, the entire array of gratings is not necessarily illuminated by the reflected light. Instead, since typically only a portion of the target is illuminated at one time, the receiving lens provides focus of the reflected light onto only a subset of the receive array.

In this manner the scene is illuminated and recorded in a time-multiplexed manner. Each subset of the scene is typically illuminated for 10's of microseconds, but can be shortened to as a little as 1 μs, or a longer integration time, up to milliseconds or seconds, can be used to be achieve better resolution.

In the phased array approach, time-division multiplexing still occurs but due to the fact that the light is point-by-point steered to the target and received from each reflected target point. The entire phased array is active, with signal combination in the photonic or electrical domain before a single detector is used to convert from the optical to electrical domain. Thus, the readout circuitry architecture and design tradeoffs are fundamentally different. This means that the light is first transmitted through the phased array and then received back through the same system, doubling the dB-loss of the optical signal path.

For multi-pixel readout systems (e.g. line arrays on mechanically rotating assemblies), each pixel is dedicated to a readout channel, or multiplexed to a small number of readout channels with a low multiplexing ratio (e.g. 2 or 4). This leads to a simplified circuit architecture with fundamentally different requirements.

Example uses include general 3D imaging such as LiDAR applications (e.g. autonomous vehicles or mapping) where high resolution and frame rate and thus multiple channel output is necessary.

Additionally, the system here can be augmented to include one or more of the following mechanisms: (1) Passive multiplexing in each pixel, instead of active amplification with in-built multiplexing via a high impedance output state, (2) Passive multiplexing at the pixel group level instead of active amplification with in-built multiplexing via a high impedance output state, and (3) Per pixel readout with single-channel operation.

The below description is discussed with reference to the reference numerals in the figures. As mentioned, a LiDAR based 3D imaging system comprises a photonic integrated circuit (PIC) transmitter and a photonic integrated circuit receiver array, according to some example embodiments. Both the transmitter and the receiver are set up in a focal plane configuration each imaged with the help of a lens. The transmitter serves to generate an optical signal with a chirped optical frequency and to perform a two axis scan of the optical beam over the region of interest. The receiver array serves to detect the difference in frequency between the return signal and a local copy of the signal using coherent detection techniques for each pixel of the two dimensional array. In one implementation all the transmitter functions are implemented on one PIC and all functions of the receiver are implemented on a second PIC. A sample architecture is shown in FIG. 1.—an optical beam having a modulated optical frequency is directed perpendicular to the transmitter PIC 101 successively from a plurality of couplers on the surface of the PIC and collimated with the help of lens 102 and directed towards the region of interest 105. In some example embodiments, the transmitter is a FMCW transmitter that prepares the beam as an outgoing continuous wave (CW) signal that has a changing optical frequency from which ranging information can be recovered (e.g., via processing of frequencies of the reflected light). The function of directing the beam to a plurality of couplers on the surface of the chip is accomplished by an in-plane optical switch. The scattered signal from region of interest 105 is captured by lens 103 and directed to the plurality of pixels located on the surface of receiver PIC 104 where couplers direct the light into the plane of the chip. Once on the plane of the chip the optical signal is combined with a copy of the local optical signal for each pixel of the receiver array and the frequency difference between the two signals is measured.

In one implementation illustrated in FIG. 2, the transmitter 201 is monolithically or hybrid-ly integrated into a single PIC and has the following architecture. A light source 202 (e.g., laser source with high coherence) is used to provide laser light with fixed optical frequency using laser driver 206. The fixed frequency laser signal is coupled into the input of a modulator 203 (e.g., an in-phase quadrature (IQ) modulator). A chirped frequency electrical signal generated by the waveform generator and amplifier 207 is used to drive the modulator 203 and convert the input fixed frequency optical signal into a chirped frequency optical signal, more specifically an optical signal whose frequency changes from f1 to f2 during a time interval t. The chirped frequency optical signal from the output of the modulator 203 or other type of modulator is passed through the optical amplifier 204 powered by amplifier driver 208, in order to be amplified. The optical amplifier 204 may be a semiconductor optical amplifier or a fiber amplifier. The output of the optical amplifier 204 serves as input for the optical beam scanning PIC 205 that directs the light towards external targets via lens 257. The optical beam scanning PIC 205 has an electronic driver 209 (e.g., a beam scanning electronic driver) associated with it. In one implementation, the optical beam scanning PIC 205 and the electronic driver 209 are monolithically integrated on the same optoelectronic chip. In one embodiment, the electrical chirp generator, the electrical signal amplifier and the modulator 203 are monolithically integrated on a single chip. In one embodiment, the integration takes place using a silicon on insulator material system or another semiconductor material system. In one embodiment, the fixed frequency laser die is integrated with the electrical chirp generator, the electrical signal amplifier and the in phase quadrature optical modulator using a hybrid approach in which a trench to accommodate the laser is etched into the monolithic silicon on insulator platform.

In one embodiment, the electrical chirp generator, the electrical signal amplifier for the modulator drive signal, the in phase quadrature optical modulator, the optical switch network used to scan the optical beam in two dimensions and the driver electronics for the optical switch network are all monolithically integrated on the same chip. In one embodiment, the integration platform is a silicon on insulator platform. In one embodiment, the integration platform contains a semiconductor material. In one embodiment, the light source 202 (e.g., a fixed frequency laser chip) and an optical amplifier 204 or plurality of optical amplifiers are integrated using a hybrid approach on the same chip as the monolithically integrated electrical chirp generator, the electrical signal amplifier for the modulator drive signal, the in phase quadrature optical modulator, the optical switch network used to scan the optical beam in two dimensions and the driver electronics for the optical switch network. The hybrid integration is achieved using a trench etched into the silicon on insulator platform and the laser and amplifier dies placed into the trench. In one embodiment, the integration platform contains a semiconductor material.

In one implementation illustrated in FIG. 2, the coherent receiver array is monolithically integrated into a single PIC. The coherent receiver PIC 210 (e.g., receiver PIC 104) is composed of an array of pixels 214, each pixel being composed of an optical coupler to couple light incident on the chip in the plane of the chip, a 2×2 optical coupler/multiplexer to combine light received from the target with a local oscillator and a coherent detector, an optical local oscillator switch network 212 driven by the switch driver 213, a readout amplification stage 215 and an analog interface 216. In one embodiment, the optical local oscillator switch network 212, the switch driver 213, the array of pixels 214, the readout amplification stage 215, and the analog interface 216 are all monolithically integrated on the same chip. In one embodiment, the integration platform used is silicon on insulator. In one embodiment, the integration platform contains a semiconductor material. A subsegment of the frequency modulated optical signal is split after the optical amplifier 204 and directed to the optical local oscillator switch network 212 to provide local oscillator optical signal for the array of pixels containing coherent detectors.

The light scattered from the region of interest is collimated by lens 211 and directed on one of the pixels containing coherent detectors that compose the array of pixels 214 (e.g., coherent detectors). The return optical signal is combined with local oscillator optical signal. The resulting optical signal, modulated at the frequency of the difference between the two optical signals is converted into the electrical domain by the photodetectors. The electrical signal is directed to the readout and amplification stages 215 and subsequently to the analog interface 216 to the image signal processor 217. The image signal processor 217 SoC contains a control and synchronization section 218 which synchronizes the functions of the transmitter and receiver PICs and analog to digital conversion section 219 which converts the analog electrical signal into a digital signal and a digital signal processing section 220 which performs the FFT on the signal and extracts the signal frequency.

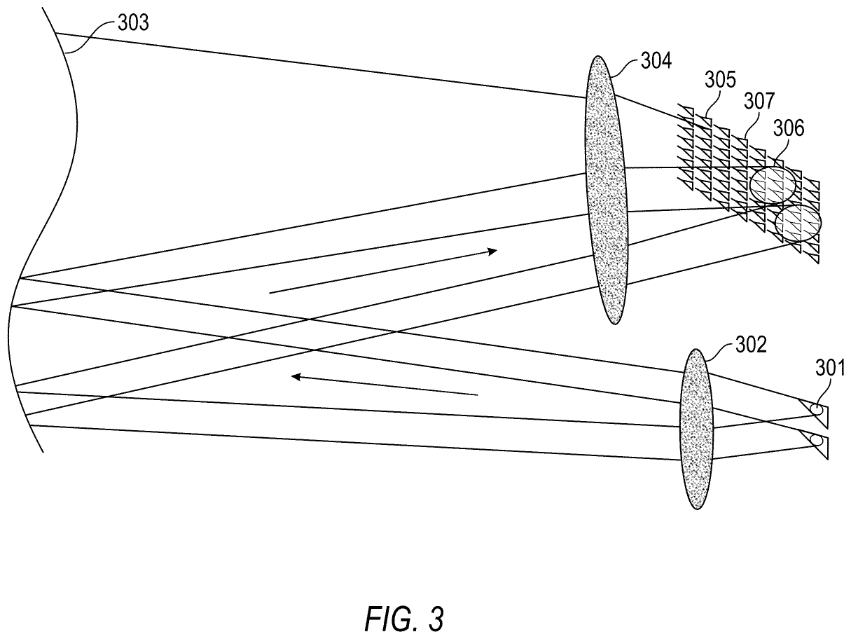

As illustrated in FIG. 3, the number of positions of the digital two axis beam scanning transmitter array chip is lower than the number of pixels of the coherent receiver array chip. In this situation one pixel of the transmitter array serves the purpose of illuminating a patch of the target corresponding to multiple pixels on the receiver side. As a consequence, the intensity of illumination of the target is reduced inversely proportional to the area being illuminated. In addition, a significant fraction of the illumination may fall on parts of the target which are imaged back on the receiver in inactive sections of the array. As in a frequency modulated continuous wave LiDAR system the strength of the return signal is proportional to the intensity of the illumination of the target, this has an effect of reducing the strength of the return signal and thereby reducing system performance. As illumination is provided for sections of the target that are not imaged by the receiver array, as they fall in the inactive areas of the receiver array, the efficiency of the system is also reduced.

In one embodiment shown in FIG. 3, emitting coupler 301 belonging to the transmitter array directs a beam through lens 302 towards target 303. The section of the target 303 illuminated by the light from coupler 301 corresponds to the area 306 from the receiver array 305 illuminated via lens 304. As the area 306 has multiple grating couplers 307 and from each grating coupler 307 only a fraction of the area of the coupler 307 effectively couples light into the plane of the receiver array a portion of light incident on the receiver array is wasted.

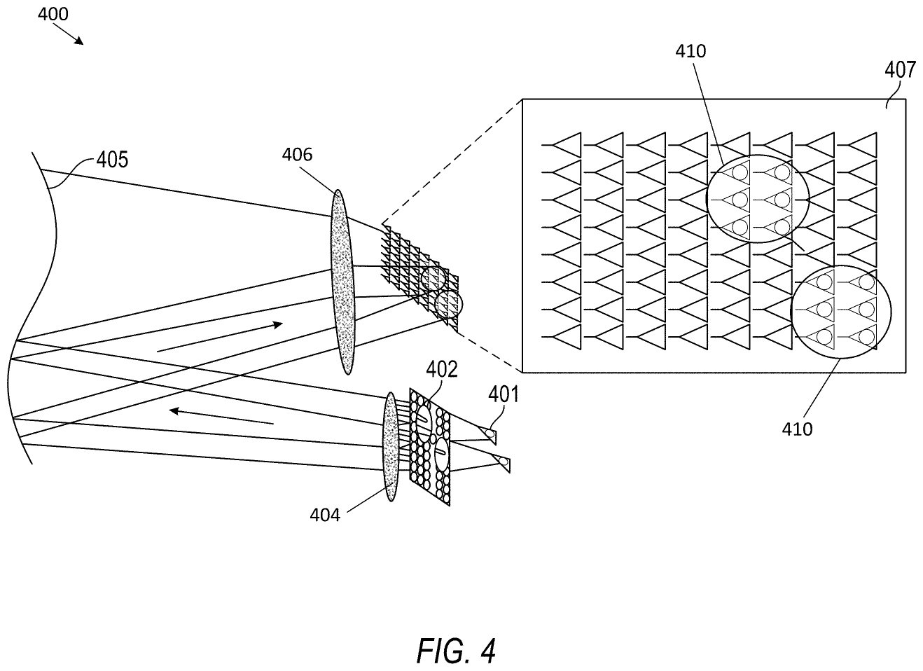

FIG. 4 shows an example architecture 400 for implementing a microlens array, according to some example embodiments. In one embodiment shown in FIG. 4, the optical efficiency is significantly improved by the addition of a microlens array 402 in the path of the beam sent out by the transmitter array. In the illustrated example, the beam from each transmitter outcoupler 401 (e.g., grating) is directed towards a section of a microlens array 402. In some example embodiments, the microlens array has a total number of microlenses that is equal to the number of receiver pixels of the receiver array 407, according to some example embodiments. By splitting the beam from each transmitter outcoupler 401 into multiple beams, matching of the number of transmit beams and receiver array pixels is achieved and the microlens array may be chosen so that the beams are focused on the target 405 to achieve maximum intensity of illumination on the target 405. By focusing the transmit beams in the segments of the target 405 that are precisely imaged by the active areas 410 of the pixels of the receiver array 407, less light is being lost through illumination of areas not being imaged and the overall efficiency of the system may be vastly improved. In some example embodiments, the transmitter lens 404 and the receiver lens 406 are configured such that the spots on the target object that are illuminated by the transmitter are imaged on the receiver as spots of equal area (e.g., equal area within as a given active area of the grating couplers of the receiver array 407) to increase efficiency.

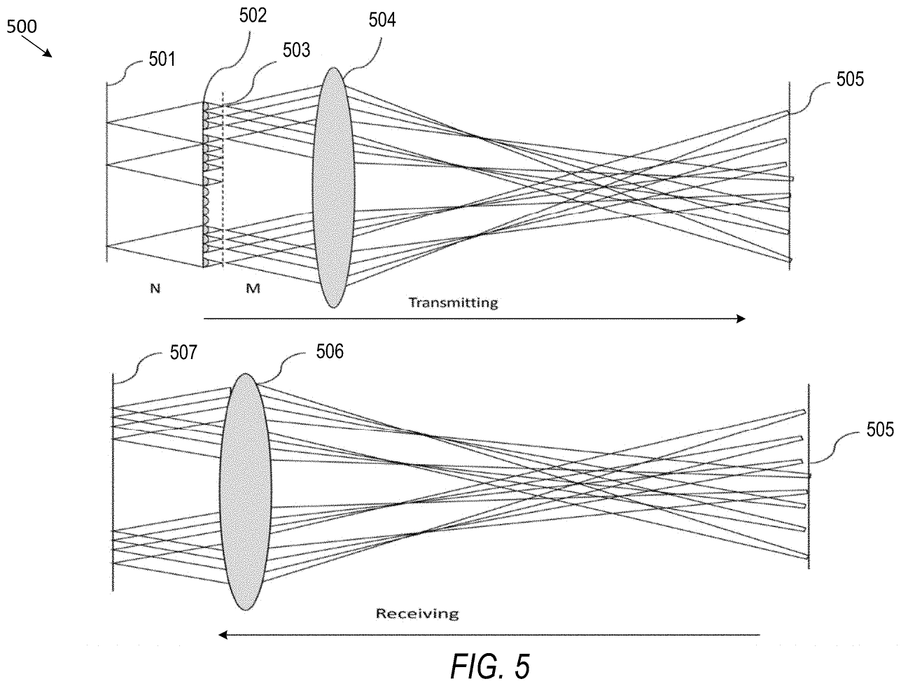

FIG. 5 shows an example architecture 500 implementing the microlens array 502, according to some example embodiments. In one embodiment, illustrated in FIG. 3, FIG. 4 and FIG. 5, each outcoupler of transmitter array 501 emits an optical frequency chirped outbound signal. The microlens array 502 splits each of the N beams emitted by the outcouplers (e.g., transmitter outcoupler 401, FIG. 4) of the transmitter array 501 into M sub beams, that converge upon the intermediate focal plan 503, and propagate towards the transmitter lens 504 which focuses the optical beams onto a plurality N×M of illumination spots on the target 505.

After reflection, the N×M illumination spots from the target 505 are imaged with the help of lens 506 on receiver array 507, with each of the N×M illumination spots imaged on an active area of a given receiver pixel. In one embodiment the number N of switching positions may be 128 and the number of microlenses M illuminated by each transmitter grating may be sixteen for a total number N×M receiver pixels of 2048. In other embodiments, the number N of switching positions may be from four to 10,000 and the number of microlenses per position may be from four to 10,000.

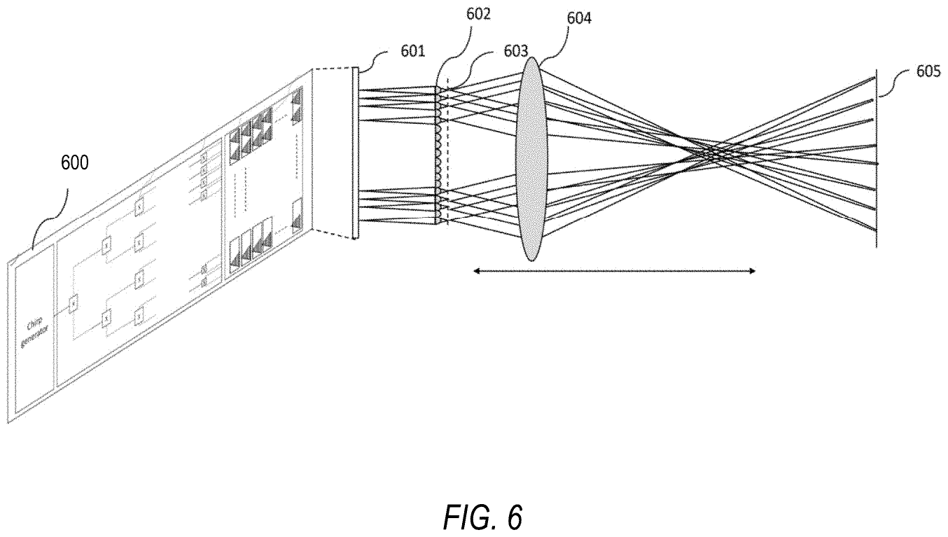

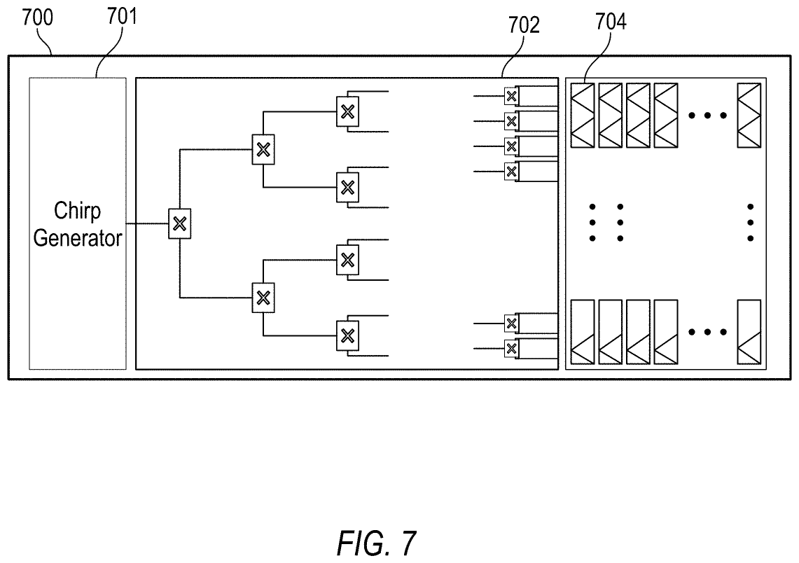

In one embodiment illustrated in FIG. 6 and FIG. 7, a microlens array 602 is implemented to create an intermediate virtual focal plane 603 before the main imaging lens that allows for transmitter beams in spots of very small diameter in the far field without the need to use prohibitively small grating couplers. In one embodiment for a 3D imaging system with overlapping inbound and outbound optical paths and that uses the same array of grating couplers for both outbound and inbound optical signals a microlens array 602 which has the same number of microlenses as pixels in the transmit array and/or the receive array, which is depicted as a single transceiver array 601 (e.g., in which each pixel or grating both transmits and receives light), according to some example embodiments. The beams emitted by the transceiver array 601 are focused in the focal plane 603 (e.g., intermediate focal plane) of the microlens array 602. The lens 604 images the small spot in the focal plane 603 onto the target 605 and then from the target 605 back though microlens array 602 and onto the gratings of the transceiver array 601 (e.g., dual mode couplings that transmit and receive), which are integrated in the single body transceiver chip structure 600 in FIG. 6, as discussed in further detail below with reference to transceiver chip structure 700 in FIG. 7.

FIG. 7 shows one embodiment of the detailed architecture of the transceiver chip structure 700, in which the outbound and inbound paths are overlapping and an array of dual mode couplers 704 are used for inbound/outbound coupling into the chip 700. In one embodiment shown in FIG. 7, the chip structure 700 includes an optical chirp generator 701 that sends a signal to an array of optical switches 702 and then further to an array of dual mode couplers 704 which transmit outbound light via the microlens array 602 (FIG. 6) and receive inbound light, as discussed above.

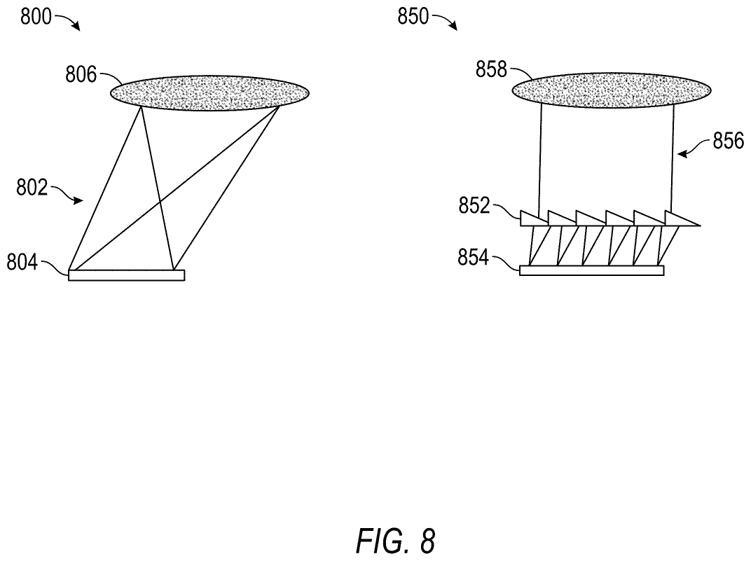

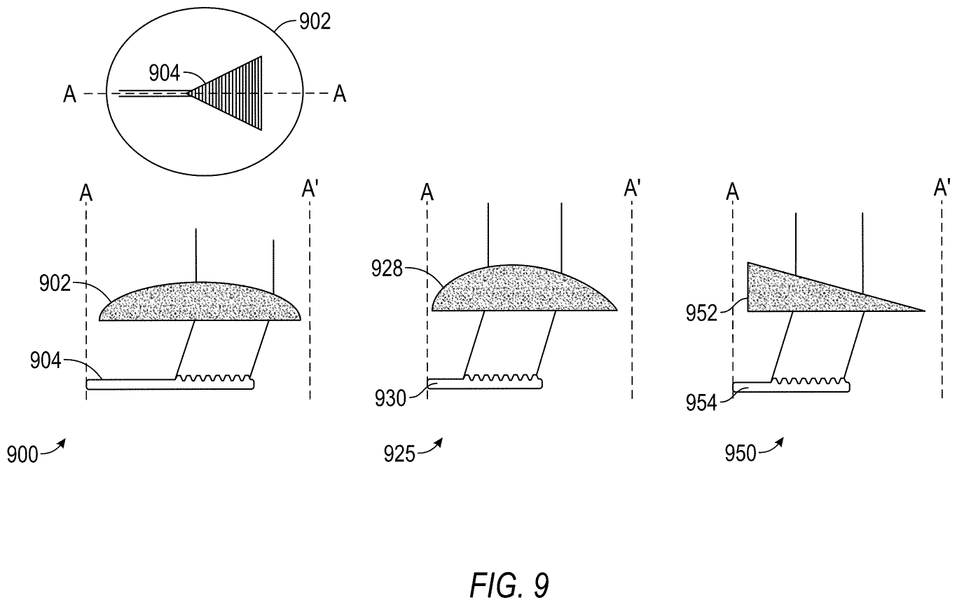

In the example embodiments in FIG. 8 and FIG. 9, a variety of optical micro elements (e.g., repeating shapes, periodic shapes, sub-lens-patterns) are implemented to create beams with the corrected optical properties.

FIG. 8 shows focal plane array imaging using grating couplers that emit at an angle with respect to the normal of the array and use of a micro prism array to correct for the departure from normal to the array emission, according to some example embodiments. In particular, as shown in the skewed embodiment 800, the light 802 generated by the transmitter unit 804 (e.g., grating) deviates or skews from the normal of the transmitter unit as it propagates toward the lens 806 due to physical properties of light (e.g., diffraction). To correct deviation from the normal, the microlens array 852 has microlens elements with shapes that incrementally correct for deviation, such that the overall beam 856 generated by transmitter unit 854 remains approximately normal to the transmitter unit 854 as it propagates to the target, such as lens 858.

In the example embodiments shown in FIG. 9, the microlens configurations 900, 925, 950 may be used in a configuration where each sub-lens's shape is offset (e.g., the shape is asymmetric or the sub-lens is offset from propagation path or axis as in 902) with respect to each of the grating elements in the array, such that a prism like effect is created that allows for angle of incidence correction in addition to the focusing function.

In the example microlens configuration 900, an asymmetric microlens sub-lens 902 may be used to correct for angle of incidence and achieve the desired collimation or focusing of the light emitted by grating 904. In the example, the microlens sub-lens 902 may be implemented as the same for some or all sub-lenses in the microlens array.

In the example microlens configuration 925, an asymmetric microlens sub-lens 928 with a more pronounced curve may be used to create a stronger correction for angle of incidence and also simultaneously achieve the desired collimation or focusing of the light emitted by grating 930. In the example, the microlens sub-lens 928 may be implemented as the same for some or all sub-lenses in the microlens array.

In the example microlens configuration 950, an asymmetrical microlens sub-lens 952 is configured as an asymmetrical microprism that is used for angle of incidence correction without additional collimation or focusing of the light emitted by grating 954. In the example, the microlens sub-lens 952 may be implemented as the same for some or all sub-lenses in the microlens array.

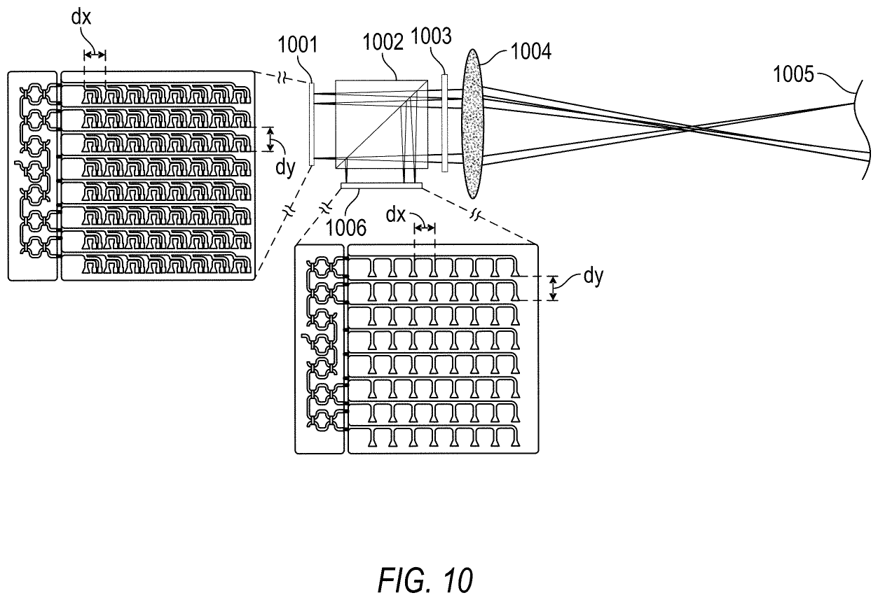

In one embodiment illustrated in FIG. 10, an example is shown of a dual focal plane array implementation of a LiDAR based 3D imaging system with overlapping transmit and receive paths where a single transmitter pixel provides illumination of the target area corresponding to a single receiver pixel, according to some example embodiments. The dual focal plane array is an example architecture in which the microlens array can be implemented, according to some example embodiments. In one embodiment the number of transmit elements of the transmitter array 1006 is the same as the number of the receiving elements of the receiver array 1001. In one embodiment, the horizontal spacing between two outcoupler elements “dx” of the transmitter array 1006 is equal with the horizontal spacing between two coupling elements of the receiver array 1001. In one embodiment, the vertical spacing between two outcoupler elements “dy” of the transmitter array 1006 is equal with the vertical spacing between two coupling elements of the receiver array 1001.

In one embodiment a plurality of beams from transmitter array 1006 is directed by the on chip outcouplers towards the beamsplitter polarizer 1002 and is reflected by the beamsplitter polarizer towards Faraday rotator 1003. Faraday rotator 1003 rotates the polarization of the outbound beam by 45 degrees. The outbound beam is directed towards lens 1004 which focuses the beam on target 1005. The plurality of scattered optical signals from target 1005 are reflected back towards lens 1004 that focuses the plurality of beams onto the plurality of coupling elements of receiver array 1001. The Faraday rotator 1003 rotates the polarization a further 45 degrees such that the inbound optical beams polarization is rotated by 90 degrees with respect to the outbound optical beams polarization. In this way, the beamsplitter polarizer 1002 is thereby used to combine the orthogonal polarization outbound and inbound optical signals without incurring any loss. In one embodiment the beamsplitter polarizer 1002 is a cube or a plate. In one embodiment an optional half waveplate may be inserted between transmitter array 1006 and beamsplitter polarizer 1002 in the case in which the polarization needs to be rotated. Similarly, an optional half waveplate may be inserted between beamsplitter polarizer 1002 and receiver array 1001 in the eventuality that the polarization of the inbound beam needs to be adjusted.

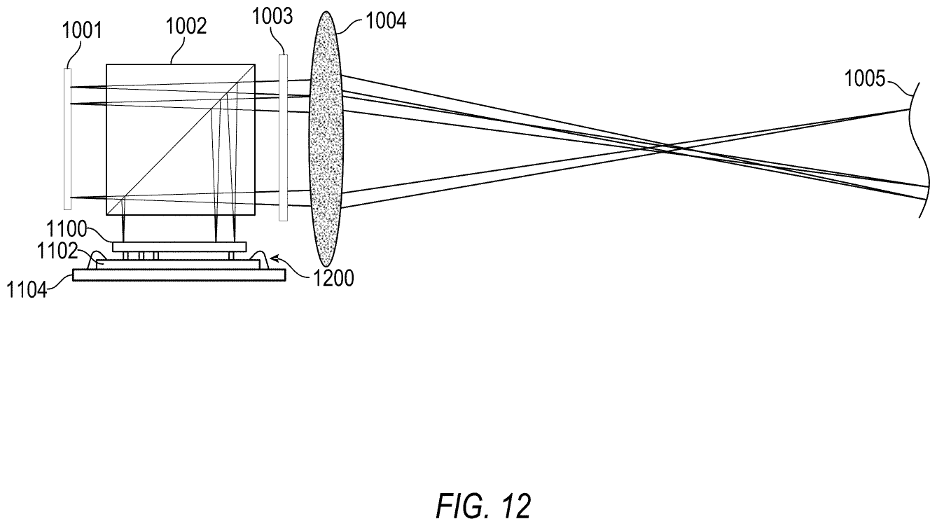

In the example embodiments, illustrated in FIG. 11 and FIG. 12 an example is shown of a dual focal plane array implementation of a LiDAR based 3D imaging system with overlapping transmit and receive paths where a single transmitter pixel provides illumination of the target area corresponding to a single receiver pixel and the transmitter electronic driver chip is separated from the photonic chip. One implementation shown in FIG. 11, a PIC 1100 (e.g., transmitter PIC) is attached to electrical circuit 1102 (e.g., ASIC, interposer), which is further mounted on a board 1104. In the example of FIG. 11, the electrical connections are implemented using ball grid arrays 1115, while the example embodiment shown in FIG. 12 implements connections using wire bonds 1200.

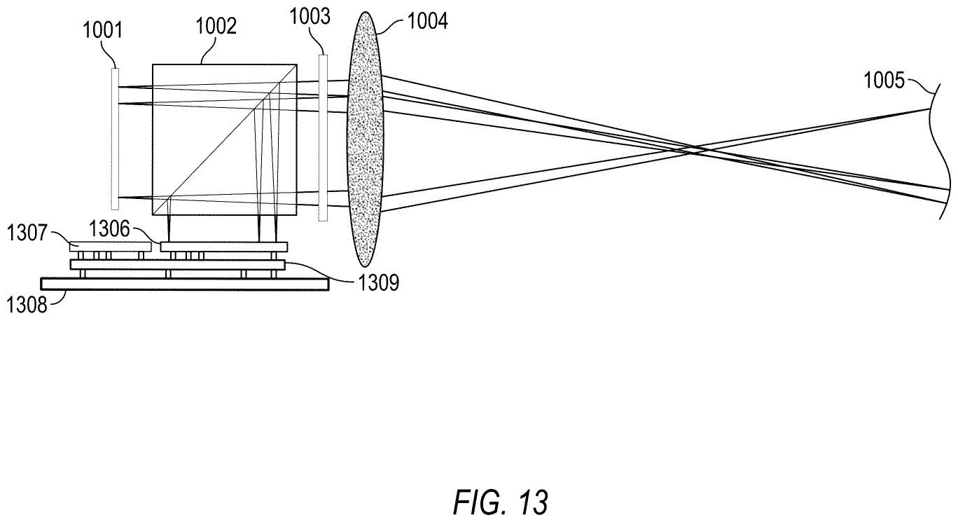

In another embodiment shown in FIG. 13, the photonic integrated circuit 1306 is connected to the electronic integrated circuit 1307 with the help of the interposer 1309 which in turn is connected to the board 1308 using a ball grid array.

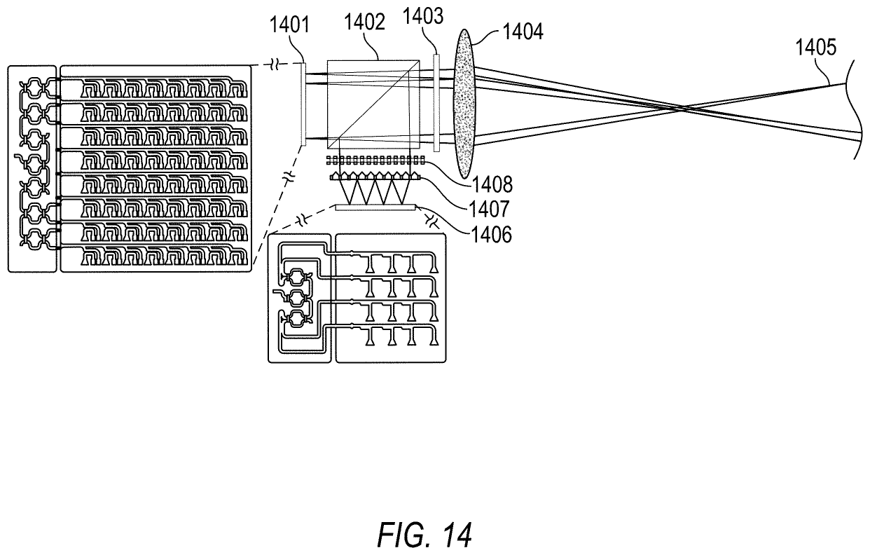

In another embodiment illustrated in FIG. 14 an example is shown of a dual focal plane array implementation of a LiDAR based 3D imaging system with overlapping transmit and receive paths where a single transmitter pixel provides illumination of the target area corresponding to multiple pixels on the receiver array with the beam from each transmitter pixel being separated into multiple beams using an array of microlenses. The optical signal emitted by the grating outcouplers from transmitter array 1406 is directed towards the microlens array 1407 which divides each of the optical beams emerging from transmitter array 1406 into multiple beams. The total number of microlenses and therefore the number of outbound beams after the microlens array 1407 is the same as the number of pixels of the receiver array 1401. The spacing of the microlenses on the microlens array 1407 is matched to the spacing of the grating couplers on the receiver array 1401 such that the outbound beams may be efficiently imaged onto the receiver array. After the microlens array 1407 the plurality of outbound beams are reflected by the beamsplitter polarizer 1402 and directed through Faraday rotator 1403 which rotates the polarization by 45 degrees and then further towards lens 1404 which focuses the plurality of outbound beams on the target 1405. The plurality of beams reflected from target 1405 are imaged with the help of lens 1404 onto the receiver array 1401. After lens 1404 the plurality of inbound optical beams are further rotated by an additional 45 degrees so that the inbound beam reflected by the target is orthogonal to the outbound beam directed towards the target and the beam splitter polarizer serves to combine the inbound and outbound beams with no loss of light. An optional half waveplate 1408 may be used on the outbound beam between the transmitter array 1406 and the beamsplitter polarizer 1402 if the polarization needs to be adjusted. Similarly an optional half waveplate may be used on the path of the inbound beam to adjust the polarization before coupling into the receiver couplers if necessary.

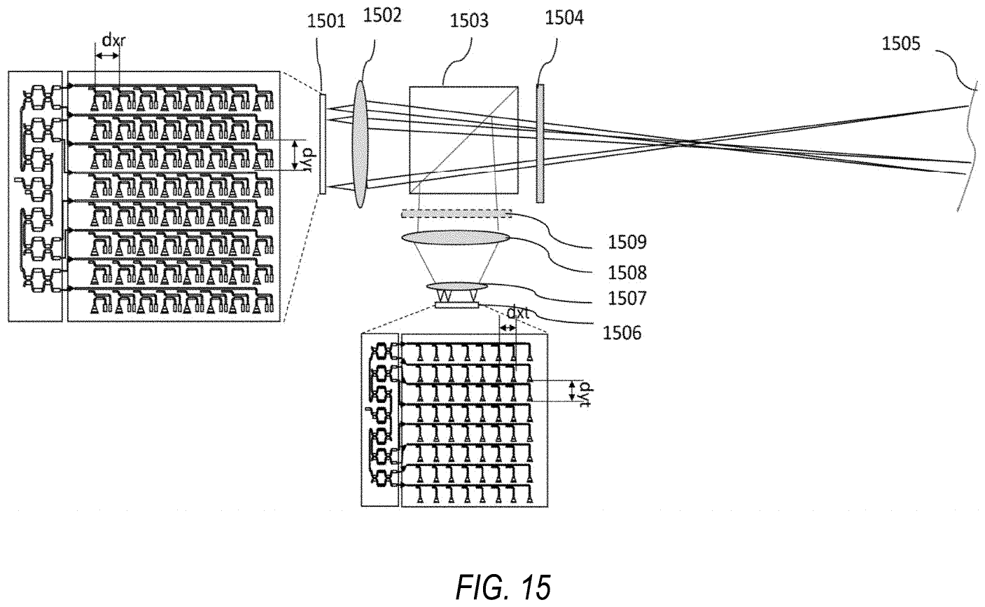

In one embodiment illustrated in FIG. 15 an example is shown of a dual focal plane array implementation of a LiDAR based 3D imaging system with overlapping transmit and receive paths where a single transmitter pixel provides illumination of the target area corresponding to a single pixel on the receiver array while the pixel to pixel separation on the transmitter and receiver arrays is not identical. In this embodiment, the light from the transmitter array 1506 is directed through one or more lens, such as lens 1507 and lens 1508 (e.g., telescope or another multi lens imaging system) that serve the purpose of converting the horizontal and vertical spacing of the transmitter array 1506 to an identical horizontal and vertical spacing as the receiver array 1501. If the number of transmitter array elements is different than the number of receiver array elements a microlens array with a number of microlenses equal to the number of receiver array elements may be introduced between array 1506 and lens 1507.

After lens 1508 and the optional half waveplate 1509 the outbound beam is reflected by beam splitter polarizer 1503 and passed through Faraday rotator 1504 towards the target 1205 with the polarization rotated by 45 degrees. The plurality of beams reflected from target 1205 are sent back towards the Faraday rotator 1504 which further rotates the polarization of the inbound beam by 45 degrees. The plurality of beams pass through the beam splitter polarizer 1503 and are focused on the receiver array with the help of lens 1502. An optional half wave plate may be used on the return path if polarization needs to be adjusted prior to coupling into the receiver array.

In some of the example embodiments discussed above, the laser operation wavelength is 1550 nm or any other wavelength between 1300 nm and 1600 nm. In some example embodiments, the transmitter array may be emitting light on the same side of the wafer as it relates to the position the metal layers (front side) or on the opposite side as it relates to the position of the metal layers (back side). Similarly, in all of the presented embodiments the receiver array may be illuminated with light through the same side with respect to the position of the metal layers (front side illumination) or may be illuminated with light through the opposite site as it relates to the position of the metal layers (back side illumination). Any combination of front and back side configured transmitter and receiver arrays may be used according to the embodiment.

In one embodiment, the detailed optical and electrical signal path and architecture illustrated in FIG. 2 applies to any of the system level architectures illustrated in FIGS. 10, 11, 12, 13, 14, and 15 except that for FIGS. 11, 12, and 13 the transmitter electrical functions may be separated onto a different chip as discussed above.

In one embodiment silicon the PICs and integrated circuits used to implement the architectures described contain silicon or another semiconductor material.

In this way, using a separate transmitter and receiver array has the advantage of flexibility of process choice for the two photonic arrays: more specifically a thinner SOI process may be used for the receiver array which requires extremely small features and very dense integration though does not have high power handling requirements, while a thicker SOI process may be used for the transmitter array which has high power handling requirements though less stringent integration density. Separation of the drive electronics for the transmitter allows for further tailoring in choice of process as a third process technology may be used for the driving electronics of the transmitter that might further optimize system performance. Through silicon vias and interposer technology may be used to enable a two chip transmitter solution—one optical and one electronic—with high density of optical switching components.

In addition the overlapping inbound/outbound path configuration eliminates any minimum distance limitations imposed by parallax in a configuration where the outbound and inbound beams do not overlap over the entire path outside the 3D imaging module and the use of a beamsplitter polarizer/Faraday rotator combination provides for lossless transmit/receive beam combining.

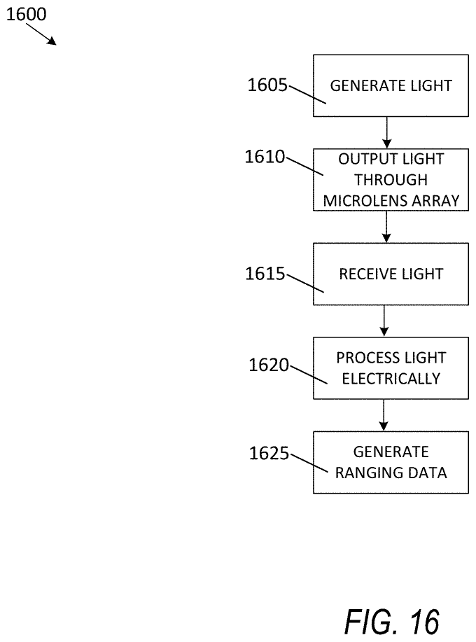

FIG. 16 shows a flow diagram of a method 1600 for implementing LiDAR using a microlens array, according to some example embodiments. At operation 1605, a transmitter array 501 generates light. At operation 1610, the light is output through a microlens array 502 and a transmitter lens 504. At operation 1615, light reflected from one or more target objects is received (e.g., through lens 506). In some example embodiments, the reflected light is received through the same microlens array, such as in the dual path configuration of FIGS. 6 and 7 (e.g., microlens array 602).

At operation 1620, the received light is electrically processed by an integrated circuit portion (e.g., FIG. 2), as discussed above. For example, the light is amplified in the PIC and the remaining components in the signal chain are implemented in a EIC that is connected to the PIC, according to some example embodiments. At operation 1625, ranging data is generated using the processed light. For example, at operation 1625, a three-dimensional point cloud image of the external objects is generated, where each point corresponds to one of the receiver pixels.

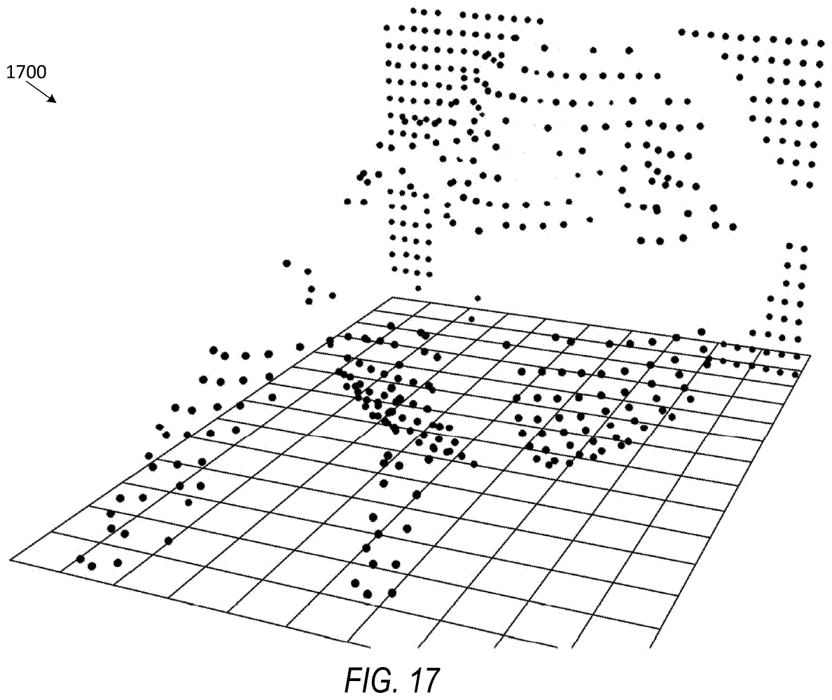

FIG. 17 shows an example point cloud 1700 generated by the backside LiDAR system, according to some example embodiments. Each of the points in the point cloud 1700 corresponds to portion of light transmitted to and reflected from one or more external objects (e.g., a man sitting in a round chair). Each of the points corresponds to one pixel in the receiver array as discussed above. For example, infrared light is transmitted to the one or more external objects, and each receiver array element (e.g., pixel) receives reflected light from a corresponding physical area of the external objects that reflected the light. Each point includes information such as three-dimensional coordinates for the given point (e.g., three orthogonal dimensions; X, Y, Z coordinates from the perspective of the receiver array,), and additional data such as velocity information for each given point.

The following are example embodiments:

Example 1. A method for generating ranging data using a light detection and ranging system comprising: generating, using a transmitter array of a photonic integrated circuit, light from one or more light sources in the light detection and ranging system; directing the light from one or more couplers to one or more external objects, the light being directed though a microlens array that outputs to a lens that directs the light towards the one or external objects; receiving light using a receiver array of the light detection and ranging system; generating, using an electronic integrated circuit of the light detection and ranging system, the ranging data from reflected light that is reflected from the one or more external objects.

Example 2. The method of example 1, wherein the light generated by the transmitter array is frequency modulated light, wherein the frequency modulated light is frequency modulated continuous wave (FMCW) light having a changing optical frequency, and wherein the light directed into the microlens array is split into a plurality of sub-beams of light that are directed to the lens and to the one or more external objects.

Example 3. The method of any of examples 1 or 2, wherein the microlens array has a plurality of sub-lenses that generate a plurality of sub-beams of light.

Example 4. The method of any of examples 1-3, wherein a first quantity of the plurality of sub-lenses of the microlens array matches a second quantity of receiver pixels of the receiver array.

Example 5. The method of any of examples 1-4, wherein the receiver array is integrated in the photonic integrated circuit.

Example 6. The method of any of examples 1-5, wherein the receiver array receives the reflected light using one or more of the couplers that transmitted the light.

Example 7. The method of any of examples 1-6, wherein the microlens array creates an intermediate focal plane between the microlens array and the lens.

Example 8. The method of any of examples 1-7, wherein one or more sub-lenses of the microlens array has a periodic shape that incrementally corrects for deviation of light propagating from the microlens array to the lens.

Example 9. The method of any of examples 1-8, wherein the periodic shape is an asymmetric lens shape.

Example 10. The method of any of examples 1-9, wherein the periodic shape is a asymmetric prism shape.

Example 11. The method of any of examples 1-10, wherein the ranging information comprises a point cloud having a plurality of points.

Example 12. The method of any of examples 1-11, wherein each point of the plurality of points is generated from light reflected from a corresponding physical area on the one or more external objects.

Example 13. The method of any of examples 1-12, wherein each point indicates one or more spatial dimension values of the corresponding physical area.

Example 14. The method of any of examples 1-13, wherein the one or more spatial dimension values comprises three orthogonal dimension values.

Example 15. The method of any of examples 1-14, wherein each point indicates a velocity value of the corresponding physical area.

Example 16. A light detection and ranging system to generate ranging data, the light detection and ranging system comprising: one or more light sources to generate light; a transmitter array in a photonic integrated circuit of the light and ranging system, the transmitter array configured to direct the light towards one or more external objects using one or more couplers and a lens; a microlens array between the one or more couplers and the lens; a receiver array to receive reflected light that is reflected from the one or more external objects; and an electronic integrated circuit to generate the ranging data from the reflected light.

Example 17. The light detection and ranging system of example 16, wherein the light generated by the transmitter array is frequency modulated light, wherein the frequency modulated light is frequency modulated continuous wave (FMCW) light having a changing optical frequency, wherein the light directed into the microlens array is split into a plurality of sub-beams of light that are directed to the lens and to the one or more external objects.

Example 18. The light detection and ranging system of any of examples 16 or 17, wherein the microlens array has a plurality of sub-lenses that generate a plurality of sub-beams of light.

Example 19. The light detection and ranging system of any of examples 16-18, wherein a first quantity of the plurality of sub-lenses of the microlens array matches a second quantity of receiver pixels of the receiver array.

Example 20. The light detection and ranging system of any of examples 16-19, wherein the receiver array is integrated in the photonic integrated circuit.

Example 21. The light detection and ranging system of any of examples 16-20, wherein the receiver array receives the light using one or more of the couplers that transmitted the light.

Example 22. The light detection and ranging system of any of examples 16-21, wherein the microlens array creates an intermediate focal plane between the microlens array and the lens.

Example 23. The light detection and ranging system of any of examples 16-22, wherein one or more sub-lenses of the microlens array has a periodic shape that incrementally corrects for division of light propagating from the microlens array to the lens.

Example 24. The light detection and ranging system of any of examples 16-23, wherein the periodic shape is an asymmetric lens shape.

Example 25. The light detection and ranging system of any of examples 16-24, wherein the periodic shape is a asymmetric prism shape.

Example 26. The light detection and ranging system of any of examples 16-25, wherein the ranging data comprises a point cloud having a plurality of points.

Example 27. The light detection and ranging system of any of examples 16-26, wherein each point of the plurality of points is generated from light reflected from a corresponding physical area on the one or more external objects.

Example 28. The light detection and ranging system of any of examples 16-27, wherein each point indicates one or more spatial dimension values of the corresponding physical area.

Example 29. The light detection and ranging system of any of examples 16-28, wherein the one or more spatial dimension values comprises three orthogonal dimension values.

Example 30. The light detection and ranging system of any of examples 16-29, wherein each point indicates a velocity value of the corresponding physical area.

What is claimed is:

1. A method for generating ranging data using a light detection and ranging system comprising:
generating, using a transmitter array of a photonic integrated circuit, light from one or more light sources in the light detection and ranging system;
directing the light from one or more couplers to one or more external objects, the light being directed though a microlens array that outputs to a lens that directs the light towards the one or external objects;
receiving light using a receiver array of the light detection and ranging system; and
generating, using an electronic integrated circuit of the light detection and ranging system, the ranging data from reflected light that is reflected from the one or more external objects.

2. The method of claim 1, wherein the light generated by the transmitter array is frequency modulated light.

3. The method of claim 2, wherein the frequency modulated light is frequency modulated continuous wave (FMCW) light having a changing optical frequency.

4. The method of claim 1, wherein the light directed into the microlens array is split into a plurality of sub-beams of light that are directed to the lens and to the one or more external objects.

5. The method of claim 1, wherein the microlens array has a plurality of sub-lenses that generate a plurality of sub-beams of light.

6. The method of claim 5, wherein a first quantity of the plurality of sub-lenses of the microlens array matches a second quantity of receiver pixels of the receiver array.

7. The method of claim 1, wherein the receiver array is integrated in the photonic integrated circuit.

8. The method of claim 1, wherein the receiver array receives the reflected light using one or more of the couplers that transmitted the light.

9. The method of claim 1, wherein the microlens array creates an intermediate focal plane between the microlens array and the lens.

10. The method of claim 1, wherein one or more sub-lenses of the microlens array has a periodic shape that incrementally corrects for deviation of light propagating from the microlens array to the lens.

11. The method of claim 10, wherein the periodic shape is an asymmetric lens shape.

12. The method of claim 10, wherein the periodic shape is a asymmetric prism shape.

13. The method of claim 1, wherein the ranging data comprises a point cloud having a plurality of points.

14. The method of claim 13, wherein each point of the plurality of points is generated from light reflected from a corresponding physical area on the one or more external objects.

15. The method of claim 14, wherein each point indicates one or more spatial dimension values of the corresponding physical area.

16. The method of claim 15, wherein the one or more spatial dimension values comprises three orthogonal dimension values.

17. The method of claim 14, wherein each point indicates a velocity value of the corresponding physical area.

18. A light detection and ranging system to generate ranging data, the light detection and ranging system comprising:
one or more light sources to generate light;
a transmitter array in a photonic integrated circuit of the light and ranging system, the transmitter array configured to direct the light towards one or more external objects using one or more couplers and a lens;
a microlens array between the one or more couplers and the lens;
a receiver array to receive reflected light that is reflected from the one or more external objects; and
an electronic integrated circuit to generate the ranging data from the reflected light.

19. The light detection and ranging system of claim 16, wherein the light directed into the microlens array is split into a plurality of sub-beams of light that are directed to the lens and to the one or more external objects.

20. The light detection and ranging system of claim 16, wherein the microlens array has a plurality of sub-lenses that generate a plurality of sub-beams of light.
